(19) United States
(12) Patent Application Publication
(10) Pub. No.: US 2009/0174647 A1
(43) Pub. Date: Jul. 9, 2009

(54) Liquid Crystal Display Panel of a Liquid Crystal Display Apparatus Comprising a Photo-Sensing Device

(75) Inventors: Pei-Yu Chen, Hsin-Chu (TW); Hung-Wei Tseng, Hsin-Chu (TW); Chun-Huai Li, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/171,664

(22) Filed: Jul. 11, 2008

(30) Foreign Application Priority Data
Jan. 8, 2008 (TW) 97100731

(51) Int. Cl. G09G 3/36; G01J 1/32

(52) U.S. Cl. 345/102; 250/205

(57) ABSTRACT

A liquid crystal display panel of a liquid crystal display apparatus comprising a photo-sensing device is provided. The liquid crystal display apparatus comprises a liquid crystal display panel and a backlight module. The liquid crystal display panel comprises a first substrate, a second substrate, a liquid crystal layer, at least one photo-sensing device and a visible light-absorbing layer. At least one photo-sensing device is placed on a photo-sensing region of the first substrate to receive an incident light, wherein the photo-sensing device comprises a first photo-sensing element and a second photo-sensing element. The first photo-sensing element senses the incident light to generate a first current. The visible light-absorbing layer is placed on the second photo-sensing element to absorb the visible light of the incident light, and further make the second photo-sensing element senses the absorbed incident light to generate a second current.

This application claims priority to Taiwan Application Serial Number 97100731, filed Jan. 8, 2008, which is herein incorporated by reference.

### BACKGROUND

1. Field of Invention

The present invention relates to a photo-sensing device. More particularly, the present invention relates to a photo-sensing device in a liquid crystal display panel of a liquid crystal display apparatus.

2. Description of Related Art

Progress in technology has resulted in portable communication devices becoming more important and popular. The demand on high contrast, high resolution, high saturation and uniform brightness has become an important issue of the liquid crystal display panels on the current portable communication devices.

A photo-sensing device on the panel is often used to adjust the panel brightness. By sensing the intensity of the light in the environment, the photo-sensing device generates a current. If the intensity of the light in the environment is strong, the current value is high as well. Thus, the panel brightness decreases. Conversely, if the intensity of the light in the environment is weak, the current value is low. Thus, the panel brightness increases. The brightness is adjusted with the method described above to make users feel comfortable when looking at the liquid crystal display.

The light in the environment, the ambient light, comprises of both visible light and invisible light. Nevertheless, such photo-sensing devices always misjudge the intensity of the visible light in the environment because of the effects of invisible light. Only visible light affects human visual perception. Invisible light mainly comprises infrared light and ultraviolet light. Infrared light is mostly responsible for generating incorrect light intensity readings of the ambient light. Halogen lamps and light sources with a 2856 K color temperature in the proximity of the liquid crystal display generate a large amount of infrared light and the photo-sensing device on the panel will therefore detect a very high brightness level. The corresponding brightness adjustments made to the liquid crystal display will make viewing the screen uncomfortable. The screen brightness may even be adjusted to levels that are harmful to human eyes.

Accordingly, what is needed is a photo-sensing device to detect the substantial intensity of the visible light of the environment and adjusting the brightness to overcome the above issues. The present invention addresses such a need.

### SUMMARY

A photo-sensing device adapted in a liquid crystal display panel to receive an incident light is provided. The photo-sensing device comprises: a first photo-sensing element, a second photo-sensing element and a visible light-absorbing layer. The first photo-sensing element for sensing the incident light to generate a first current; the second photo-sensing element electrically connected to the first photo-sensing element; and the visible light-absorbing layer placed on the second photo-sensing element on the photo-sensing region to absorb the visible light of the incident light, and further make the second photo-sensing element sense the absorbed incident light to generate a second current.

Another object of the present invention is to provide a liquid crystal display panel adapted in a liquid crystal display apparatus that has a backlight module, wherein the liquid crystal display panel comprises: a first substrate, a second substrate, a liquid crystal layer and at least one photo-sensing device. The first substrate comprises a pixel area and a photo-sensing area, wherein pixel area is surrounded by the pixel area; the second substrate is placed in parallel above the first substrate; the liquid crystal layer placed between the first and the second substrate; at least one photo-sensing device is placed on the first substrate in the photo-sensing area to receive an incident light, wherein the photo-sensing device comprises: a first photo-sensing element, a second photo-sensing element and a visible light-absorbing layer. The first photo-sensing element for sensing the incident light to generate a first current; the second photo-sensing element electrically connected to the first photo-sensing element; and the visible light-absorbing layer placed on the second photo-sensing element on the photo-sensing region to absorb the visible light of the incident light, and further make the second photo-sensing element sense the absorbed incident light to generate a second current.

Yet another object of the present invention is to provide a liquid crystal display apparatus comprising: a first substrate, a second substrate, a liquid crystal layer and at least one photo-sensing device. The first substrate comprises a pixel area and a photo-sensing area, wherein pixel area is surrounded by the pixel area; the second substrate is placed in parallel above the first substrate; the liquid crystal layer placed between the first and the second substrate; at least one photo-sensing device is placed on the first substrate in the photo-sensing area to receive an incident light, wherein the photo-sensing device comprises: a first photo-sensing element, a second photo-sensing element and a visible light-absorbing layer. The first photo-sensing element senses the incident light to generate a first current; the second photo-sensing element electrically connected to the first photo-sensing element; and the visible light-absorbing layer placed on the second photo-sensing-element on the photo-sensing region absorbs the visible light of the incident light, and further makes the second photo-sensing element sense the absorbed incident light to generate a second current.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a block diagram of the liquid crystal display apparatus of the first embodiment of the present invention;

FIG. 1B is a top view of the first substrate of the liquid crystal display panel of the first embodiment of the present invention;

FIG. 2A is a cross-sectional view of the liquid crystal display panel of the first embodiment of the present invention;

FIG. 2B is a diagram of the photo-sensing device of the first embodiment of the present invention;

FIG. 2C is a cross-sectional view of the liquid crystal display panel of the second embodiment of the present invention;

FIG. 3 is a block diagram of the photo-sensing device of the first embodiment of the present invention; and

FIG. 4 is a cross-sectional view of the liquid crystal display panel of the third embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

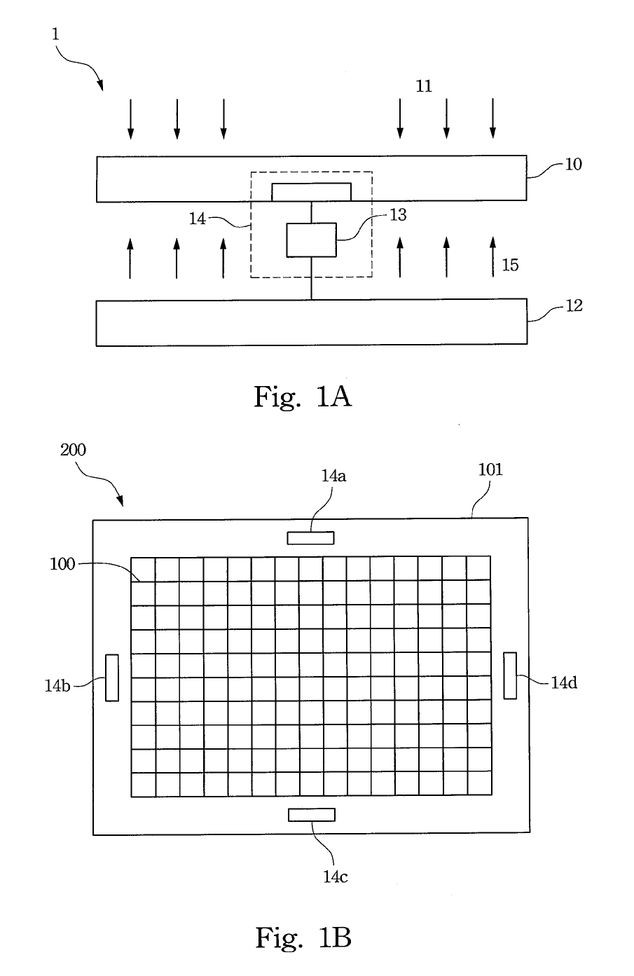

Please refer to FIG. 1A, a block diagram of a liquid crystal apparatus 1 of the first embodiment of the present invention. The liquid crystal apparatus 1 comprises a liquid crystal display panel 10 and a back light module 12. The liquid crystal display panel 10 comprises a photo-sensing device 14. The photo-sensing device 14 receives an incident light 11 and generates a current through a control circuit 13 of the photo-sensing device 14 to adjust the brightness 15 of the display panel 10. FIG. 1B is a top view of a first substrate 200 of the liquid crystal display panel. The first substrate 200 comprises a pixel area 100 and a photo-sensing area 101, wherein the photo-sensing area 101 surrounds the pixel area 100. The photo-sensing devices 14a, 14b, 14c and 14d are placed on the four corners of the photo-sensing area 101 to receive an incident light. People skilled in the art can easily adjust the number and the size of the photo-sensing device 14 in other embodiment.

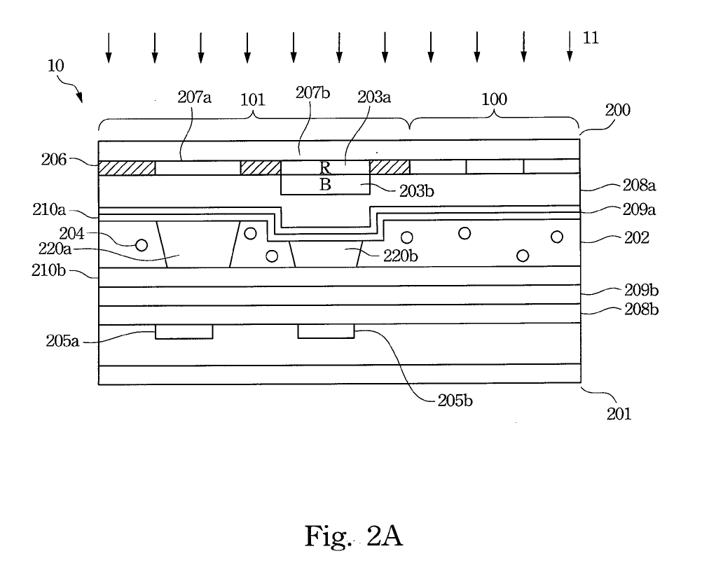

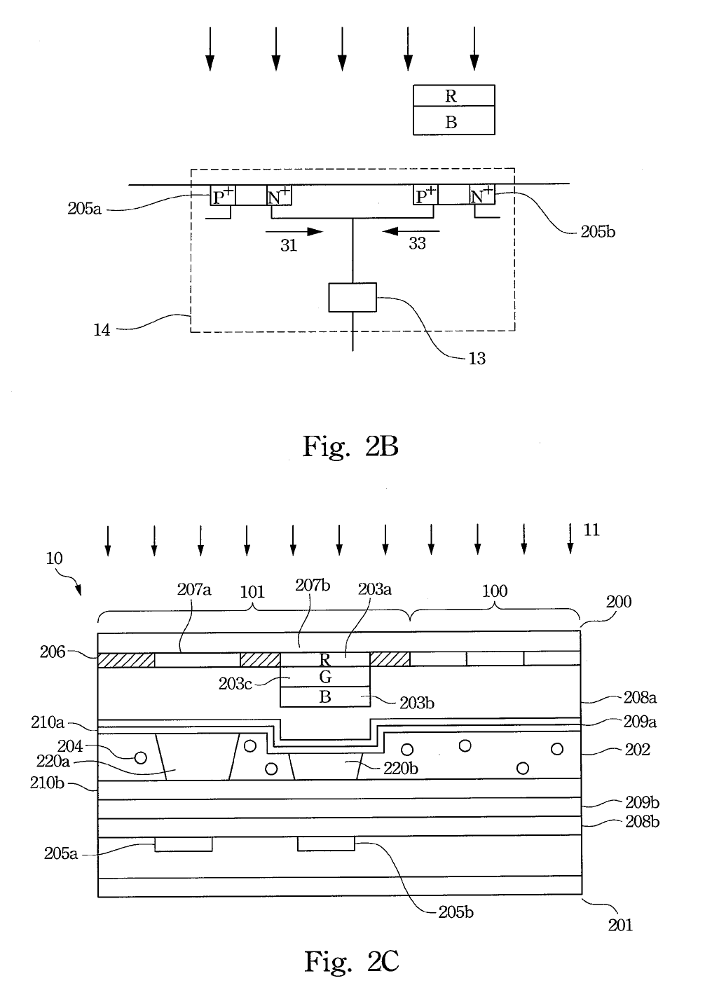

FIG. 2A is a cross-sectional view of the liquid crystal display panel 10 of the first embodiment of the present invention. The liquid crystal display panel 10 comprises a first substrate 200, a second substrate 201, a liquid crystal layer 202 and a visible light-absorbing layer 203. The first substrate 200 comprises a pixel area 100 and a photo-sensing area 101. The second substrate 201 is placed in parallel above the first substrate 200. The liquid crystal layer 202 is placed between the first and the second substrate 200 and 201 and comprises a liquid crystal material 204. Between the first and second substrate 200 and 201 further comprises a photo-spacer to maintain the distance between the first and second substrates 200 and 201. The second substrate 201 comprises a first photo-sensing element 205a and a second photo-sensing element 205b electrically connected together. The first and second photo-sensing sensing element 205a and 205b are in the photo-sensing device 14 as shown in FIG. 2B. Photo-spacers can be selectively placed on the top of the first and second photo-sensing sensing element 205a and 205b such as the photo-spacers 220a and 220b in FIG. 2A. The photo-sensing device 14 is on the second substrate 201 of the photo-sensing area 101 to receive an incident light 11. The photo-sensing device 14 comprises the first photo-sensing sensing element 205a to generate a first current 31 and the second photo-sensing sensing element 205b. The first and the second photo-sensing element comprise a PIN (positive-intrinsic-negative) diode, a photo transistor or other kind of semiconductor device respectively. In the present embodiment, the first substrate 200 further comprises a black matrix 206 surrounding the pixel area 100, wherein the black matrix 206 has a first opening 207a and a second opening 207b corresponding to the first and the second photo-sensing element 205a and 205b of each photo-sensing device such that the incident light 11 only passes through the first and the second opening 207a and 207b.

The first substrate 200 further comprises an over coat layer 208a on the black matrix 206 and the visible light-absorbing layer 203. An indium tin oxide layer 209a and a polymide layer 210a are relatively placed (faced to the liquid crystal layer 202) on the overcoat layer 208a, wherein the indium tin oxide layer 209a is on the over coat layer 208a and the polymide layer 210a is on the indium tin oxide layer 209a. The second substrate 201 further comprises an over coat layer 208b on the pixel area 100 and the photo-sensing layer 101. On the over coat layer 208b are an indium tin oxide layer 209b and a polymide layer 210b, wherein the indium tin oxide layer 209b is on the over coat layer 208b and the polymide layer 210b is on the indium tin oxide layer 209b.

As shown in FIG. 2A and FIG. 2B, the visible light-absorbing layer is placed on the top of the second photo-sensing element 205b of the photo-sensing-area 101, in other words, on the top of the second opening 207b of the first substrate 200 to absorb or filter out the visible light of the incident light 11. The remaining part of the absorbed incident light or the filtered incident light comprises the ultraviolet and the infrared light, and mostly is the infrared light. The second photo-sensing element senses the remaining part of the incident light 11 to generate a second current 33. In the present embodiment, the visible light-absorbing layer comprises a red light-absorbing layer 203a and a blue light-absorbing layer 203b to absorb the visible light. The photo-sensing device further comprises a control circuit 13 connecting the first and second photo-sensing element 205a and 205b. The control circuit 13 adjusts the brightness 15 of the back light module 12 in FIG. 1A according to the difference of the first and second current 31 and 33, which stands for the light intensity without the invisible light. The first and second photo-sensing element 205a and 205b can output the current difference directly to the control circuit 13. In other embodiment, a calculating module in the control circuit 13 calculates the difference according to current value sent from the first and second photo-sensing element 205a and 205b respectively. The photo-sensing device 14 can detect the effect of the invisible light to accurately adjust the brightness of the liquid crystal display panel 10. In other embodiment, the visible light-absorbing layer comprises a red light-absorbing layer 203a, a blue light-absorbing layer 203b and a green light-absorbing layer 203c to absorb the visible light and the ultraviolet to make even more accurate adjustment of the brightness.

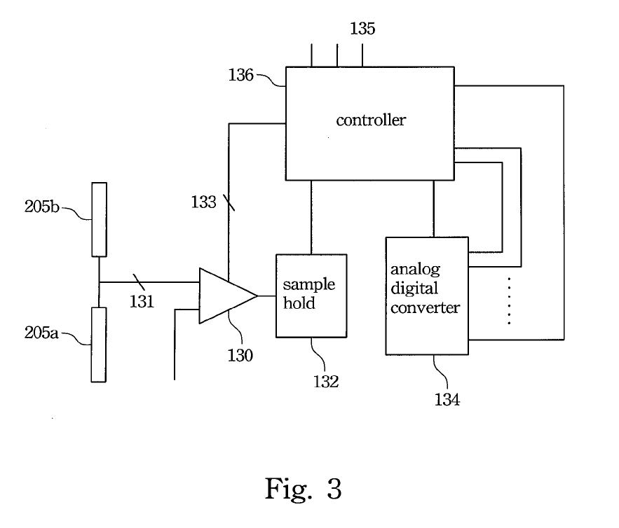

FIG. 3 is a clearer block diagram of the photo-sensing device 14. The first and second photo-sensing element 205a and 205b output a differential current 131 to a current/voltage converter 130. After the process of a adjustable coefficient 133 and a sample/hold device 132, an analog voltage signal is produced. The analog/digital converter 134 converts the analog voltage signal into a digital voltage signal. The controller 135 computes the value of the substantial environment brightness to adjust the brightness 15 of the back light module 12 to match the need of the eyes of the human.

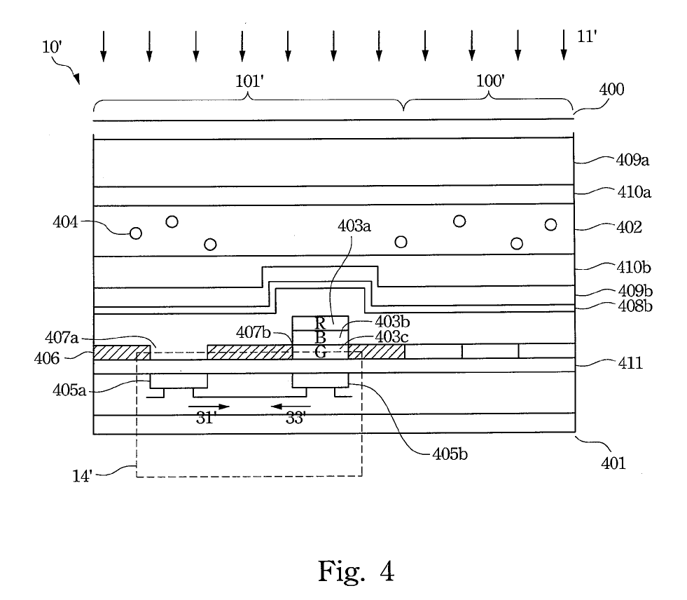

FIG. 4 is a cross-sectional view of the liquid crystal display panel 10′ of the third embodiment of the present invention, wherein the liquid crystal display panel 10′ can be adapted to the liquid crystal display apparatus 1 of the first embodiment. The liquid crystal display panel 10′ comprises a first substrate 400, a second substrate 401, a liquid crystal layer 402 and a visible light-absorbing layer 403. The first substrate 400 comprises a pixel area 100′ and a photo-sensing area 101′. The second substrate 401 is placed in parallel In above the first substrate 400. The liquid crystal layer 402 is placed between the first and the second substrate 400 and 401 and comprises a liquid crystal material 404. The second substrate 401 comprises a first photo-sensing element 405a and a second photo-sensing element 405b electrically connected together. The first and second photo-sensing sensing element 405a and 405b are in the photo-sensing device 14 as in the first embodiment. The first and the second photo-sensing element 405a and 405b comprise a PIN diode, a photo transistor or other kind of light-sensing semiconductor device respectively. In the present embodiment, the second substrate 401 further comprises a dielectric layer 411 covering the second substrate 401. On the dielectric layer 411 is a black matrix 406 on the photo-sensing area 101′, wherein the black matrix 406 has a first opening 407a and a second opening 407b corresponding to the first and the second photo-sensing element 405a and 405b of each photo-sensing device such that the incident light 11′ only passes through the first and the second opening 407a and 407b.

The first substrate 400 further comprises an indium tin oxide layer 409a and a polymide layer 410a, wherein the polymide layer 410a is on the indium tin oxide layer 409a. The second substrate 401 further comprises an over coat layer 408b covering the black matrix 406 and the visible light-absorbing layer 403. On the over coat layer 408b are an indium tin oxide layer 409b and a polymide layer 410b, wherein the indium tin oxide layer 409b is on the over coat layer 408b and the polymide layer 410b is on the indium tin oxide layer 409b.

The visible light-absorbing layer 403 is placed on the top of the second photo-sensing element 405b of the photo-sensing area 101′. In other words, on the top of the second opening 407b of the second substrate 401 to absorb the visible light of the incident light 11′. The second photo-sensing element senses the remaining part of the incident light 11′ to generate a second current. In the present embodiment, the visible light-absorbing layer comprises a red light-absorbing layer 403a, a blue light-absorbing layer 403b and a green light-absorbing layer 403c to absorb the visible light and the ultraviolet. The photo-sensing device further comprises a control circuit connecting the first and second photo-sensing element 405a and 405b as in the first embodiment. The control circuit adjusts the brightness 15 of the back light module according to the difference of the first and second current, which stands for the light intensity without the invisible light. The photo-sensing device 14 can detect the effect of the invisible light. After the exclusion of the ultraviolet, the effect of the infrared light can be detected more accurately, and the more accurate adjustment of the brightness of the liquid crystal display panel 10 can be made. In other embodiment, the visible light-absorbing layer comprising a red light-absorbing layer and a blue light-absorbing layer can be adapted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A photo-sensing device adapted in a liquid crystal display apparatus to receive an incident light, wherein the photo-sensing device comprises:
a first photo-sensing element to sense the incident light to generate a first current;
a second photo-sensing element electrically connected to the first photo-sensing element; and
a visible light-absorbing layer placed on the second photo-sensing element on the photo-sensing region to absorb the visible light of the incident light, and further make the second photo-sensing element sense the absorbed incident visible light to generate a second current.

2. The photo-sensing device of claim 1, wherein the first and the second photo-sensing element comprises a PIN diode respectively.

3. The photo-sensing device of claim 1, wherein the visible light-absorbing layer comprises a red light-absorbing layer and a blue light-absorbing layer.

4. The photo-sensing device of claim 1, wherein the visible light-absorbing layer comprises a red light-absorbing layer, a blue light-absorbing layer and a green light-absorbing layer.

5. The photo-sensing device of claim 1, further comprising a control circuit connected to the first and the second photo-sensing element to adjust the brightness of the backlight module according to the first and the second current.

6. The photo-sensing device of claim 1, further comprising a connection between the first and the second photo-sensing element to generate a differential current of the first and the second current.

7. A liquid crystal display panel adapted in a liquid crystal display apparatus that has a backlight module, wherein the liquid crystal display panel comprises:
a first substrate comprising a pixel area and a photo-sensing area, wherein pixel area is surrounded by the pixel area;
a second substrate placed in parallel above the first substrate;
a liquid crystal layer placed between the first and the second substrate;
at least one photo-sensing device placed on the first substrate in the photo-sensing area to receive an incident light, wherein the photo-sensing device comprises:
a first photo-sensing element for sensing the incident light to generate a first current;
a second photo-sensing element electrically connected to the first photo-sensing element; and
a visible light-absorbing layer placed on the second photo-sensing element on the photo-sensing region to absorb the visible light of the incident light, and further make the second photo-sensing element sense the absorbed incident light to generate a second current.

8. The liquid crystal display panel of claim 7, further comprising a black matrix surrounding the pixel area, wherein the black matrix has a first opening and a second opening corresponding to the first and the second photo-sensing element of each photo-sensing device such that the incident light only passes through the first and the second opening.

9. The liquid crystal display panel of claim 7, wherein the second substrate further comprises an over coat layer thereon.

10. The liquid crystal display panel of claim 9, wherein the second substrate further comprises an indium tin oxide layer and a polymide layer, is wherein the indium tin oxide layer is on the over coat layer and the polymide layer is on the indium tin oxide layer.

11. The liquid crystal display panel of claim 7, wherein the first substrate further comprises an over coat layer on the pixel area and the photo-sensing layer.

12. The liquid crystal display panel of claim 11, wherein the first substrate further comprises an indium tin oxide layer and a polymide layer, wherein the indium tin oxide layer is on the over coat layer and the polymide layer is on the indium tin oxide layer.

13. The liquid crystal display panel of claim 7 further comprising a photo spacer in the liquid crystal layer.

14. The liquid crystal display panel of claim 7, wherein the first and the second photo-sensing element comprises a PIN diode respectively.

15. The liquid crystal display panel of claim 7, wherein the visible light-absorbing layer comprises a red light-absorbing layer and a blue light-absorbing layer.

16. The liquid crystal display panel of claim 7, wherein the visible light-absorbing layer comprises a red light-absorbing layer, a blue light-absorbing layer and a green light-absorbing layer.

17. The liquid crystal display panel of claim 7, further comprising a control circuit connected to the first and the second photo-sensing element to adjust a brightness of the backlight module according to the first and the second current.

18. The liquid crystal display panel of claim 7, further comprising a connection between the first and the second photo-sensing element to generate a differential current of the first and the second current.

19. A liquid crystal display apparatus comprises:
a first substrate comprising a pixel area and a photo-sensing area, wherein pixel area is surrounded by the photo-sensing area;
a second substrate placed in parallel above the first substrate;
a liquid crystal layer placed between the first and the second substrate;
at least one photo-sensing device placed on the first substrate in the photo-sensing area to receive an incident light, wherein the photo-sensing device comprises:
a first photo-sensing element for sensing the incident light to generate a first current;
a second photo-sensing element electrically connected to the first photo-sensing element; and
a visible light-absorbing layer placed on the second photo-sensing element on the photo-sensing region to absorb the visible light of the incident light, and further make the second photo-sensing element sense the absorbed incident light to generate a second current.

20. The liquid crystal display apparatus of claim 19, further comprising a black matrix surrounding the pixel area, wherein the black matrix has a first opening and a second opening corresponding to the first and the second photo-sensing element of each photo-sensing device such that the incident light only passes through the first and the second opening.

21. The liquid crystal display apparatus of claim 19, wherein the first and the second photo-sensing element comprises a PIN diode respectively.

22. The liquid crystal display apparatus of claim 19, wherein the visible light-absorbing layer comprises a red light-absorbing layer and a blue light-absorbing layer.

23. The liquid crystal display apparatus of claim 19, wherein the visible light-absorbing layer comprises a red light-absorbing layer, a blue light-absorbing layer and a green light-absorbing layer.

24. The liquid crystal display apparatus of claim 19, further comprising a control circuit connected to the first and the second photo-sensing element to adjust a brightness of the backlight module according to the first and the second current.

25. The liquid crystal display apparatus of claim 19, further comprising a connection between the first and the second photo-sensing element to generate a differential current of the first and the second current.
